(19) United States
(12) Patent Application Publication
(10) Pub. No.: US 2008/0041559 A1
(43) Pub. Date: Feb. 21, 2008

(54) Heat exchanger for vehicle

(75) Inventors: Jun Gil Woong, Daedeok-gu (KR); Sim Ho Chang, Daedeok-gu (KR); Jeong Sun An, Daedeok-gu (KR); Kim Kwang Il, Daedeok-gu (KR); Lee Sang Yul, Daedeok-gu (KR); Cho Byoung Sun, Daedeok-gu (KR)

Correspondence Address: THE WEBB LAW FIRM, P.C., 700 KOPPERS BUILDING, 436 SEVENTH AVENUE, PITTSBURGH, PA, 15219, US

(73) Assignee: Halla Climate Control Corp., Daedeok-gu (KR)

(21) Appl. No.: 11/505,031

(22) Filed: Aug. 16, 2006

(51) Int. Cl. B60H 1/00

(52) U.S. Cl. 165/44

(57) ABSTRACT

The present invention relates to a heat exchanger for a vehicle, and more particularly, to a highly efficient thin heat exchanger for reducing the weight of a vehicle body and enhancing heat radiation performance. In the present invention, there is provided an optimal design range for maximizing heat radiation performance of the radiator using a concept of thermal resistance. According to the present invention, there is provided a heat exchanger for exchanging heat between cooling water heated by an engine and air flowed into the front of the vehicle to cool the engine, including: a header at one side for communicating the cooling water supplied from the engine through a thermostat for adjusting opening/shutting depending on a temperature of the cooling water and a water pump; heat exchange tubes which is structurally fastened to communicate with the heater at one end portion thereof, and arranged in parallel to a direction of driving wind; a header at the other side which is structurally fastend at the other end portion of the heat exchange tube to communicate therewith, to discharge the cooling water into the engine; and fins fixedly bonded between the heat exchange tubes, wherein the inner width b and pitch Tp of the tube is determined by formula 1.50≦b×Tp^{0.2}≦1.94, which is derived from thermal resistance Rw, when the material thickness Tth of the tube is 0.15 to 0.23 mm. At this time, the heat exchange may be used as a high efficient thin radiator, and the flow of the cooling water within the tube is a turbulent flow in most regions.

### TECHNICAL FIELD

The present invention relates to a heat exchanger for a vehicle, and more particularly, to a highly efficient thin heat exchanger for reducing the weight of a vehicle body and enhancing heat radiation performance.

### BACKGROUND ART

FIG. 1 is a conceptual view showing a cooling system of a general vehicle. Since an engine 1 for a vehicle always ignites and burns high-temperature and high-pressure gas, the engine 1 is overheated in a case where it is left as it is, so that cylinders and pistons may be seriously damaged due to the melt of a metallic material constituting the engine 1. In order to prevent this, as shown in FIG. 1, a water jacket (not shown), in which cooling water is stored, is mounted around the cylinder of the engine 1 for a vehicle, the engine is circularly cooled by allowing the cooling water to pass through a radiator 2 or a heater core 3 using a water pump 5, and the cooling water may not pass through the heater core 3 but be immediately returned through a bypass circuit 6 depending on a use of cooling or heating. At this time, the thermostat 4 is mounted in a path through which the cooling water flows so as to function as an adjusting mechanism for preventing the engine 1 from being overheated by adjusting a degree of opening and shutting depending on a temperature of the cooling water passing through the engine 1.

(a) and (b) of FIG. 2 are a perspective view and an exploded perspective view of a general radiator, respectively. The radiator is a kind of heat exchanger for allowing heat of the cooling water to be radiated when the cooling water receiving heat of the engine transferred while circulating to the engine flows. The radiator is mounted to an engine room, and a cooling fan for blowing wind into the core of the engine is mounted to a central portion of the engine room.

The radiator is generally made of aluminum with a superior heat conduction effect, and has a characteristic in that heat radiation performance depends on elements of heat exchanging tubes and fins. That is, if the heights of the tube and the fin are reduced even in a radiator with the same core, the heat radiation performance is theorethically enhanced. However, if the height of the fin becomes too low, a foreign substance is stuck or stacked betweein the fins so that it interferes with ventilation, and since a foreign substance produced due to an antifreezing solution or a reactant is stacked inside the tube if the height of the tube becomes too small, there ocurrs a phenomenon in that a flow channel is blocked so that the deterioration of heat transfer performance may be rather caused. In this case, since the number of tubes and fins become large, there may be caused a problem in that this is very disadvantageous in a view of stability of a radiator structure and productivity in manufacturing.

In a case of U.S. Pat. No. 4,332,293 (1982. 6. 1) as a prior art, there is suggested a numerical range in that the length of a fin in a direction of air flow should be 12 to 23 mm, the pitch of the fin should be 1.5 to 3.3 mm, and the pitch of a tube should be 8.5 to 14 mm as elements of a radiator mounted within a range of a limited core mounting space so as to overcome air resistance generated as the length of the fin is lengthened in the direction of air flow in the radiator with a tube arrangement of 2 or 3 rows and reduction of heat transfer performance according thereto.

However, the conventional radiator is focused on heat radiation performance of an outer side of the tube through which air passes. Further, in order to prevent a pressure loss of water-side, the caliber of the tube is set not to be small and the height of the fin is simultaneously set to be relatively high considering an air-side heat transfer effect. In a case of a general radiator, there is a case where it is overlooked that, although a heat transfer rate due to heat conduction is frequently cuased due to air-side convection, a variation of the heat transfer rate is not so large as compared with a structure modification degree of its components, while, although a heat calorific value due to heat convection in a heat exchange tube has a low ratio occupying in a total heat transfer rate, it is sensitively changed depending on the structure modification degree of its component and a variation thereof is relatively large. This requires more thorough observation on flow of a cooling water in a radiator tube and the heat transfer characteristic to the inside thereof, and more researches and experiments on radiators with more effective heat radiating performance.

### DISCLOSURE OF THE INVENTION

It is an object of the present invention to provide an heat exchanger, i.e., a highly efficient thin radiator for reducing the weight of a vehicle body and enhancing heat radiation performance.

It is another object of the present invention to provide an optimal design condition for maximizing heat radiation performance of the radiator using a concept of thermal resistance.

It is a further object of the present invention to provide a preferred design range of each main component of the radiator, which can meet the optimal design range.

To achieve these objects of the present invention, there is provided a heat exchanger for a vehicle for exchanging heat between cooling water heated by an engine and air flowed into the front of the vehicle to cool the engine, including: a header at one side for communicating the cooling water supplied from the engine through a thermostat for adjusting opening and shutting depending on a temperature of the cooling water and a water pump; heat exchange tubes which is structurally fastened to communicate with the heater at one end portion thereof, and arranged in parallel to a direction of driving wind; a header at the other side which is structurally fastend at the other end portion of the heat exchange tube to communicate therewith, to discharge the cooling water into the engine; and fins fixedly brazed between the heat exchange tubes, wherein the inner width b and pitch Tp of the tube is determined by formula 1.50≦b×Tp^{0.2}≦1.94, which is derived from thermal resistance Rw, when the material thickness Tth of the tube is within the range from 0.15 to 0.23 mm. At this time, the heat exchange may be used as a high efficient thin radiator, and the flow of the cooling water within the tube is a turbulent flow in most regions.

Preferably, the inner width b of the tube is within the range from 1.02 to 1.3 mm, and the pitch Tp of the tube is within the range from 6.78 to 7.4 mm.

Preferably, the outer width Th is within the range from 1.48 to 1.6 mm, and wherein the height Fh of the fin is within the range from 5.3 to 5.8 mm.

### BRIEF DESCRIPTION OF THE DRAWINGS

FIG. 1 is a conceptual view showing a cooling system of a general vehicle.

(a) and (b) of FIG. 2 are a perspective view and an exploded perspective view of a radiator that is a general heat exchanger, respectively.

FIG. 3 is a conceptual view illustrating thermal resistance.

FIG. 4 is an enlarged perspective view showing a coupling feature of a tube and a fin in the radiator.

FIG. 5 is a graph illustrating a change in heat transfer rate and pressure loss of the radiator depending on a change in thermal resistance in the present invention.

FIG. 6 is a graph illustrating a change in heat transfer rate and pressure loss of the radiator depending on the height of the fin in the present invention.

FIG. 7 is a graph illustrating a change in heat transfer rate and pressure loss of the radiator depending on the outer width of the tube in the present invention.

FIG. 8 is a graph illustrating a change in heat transfer rate and pressure loss of the radiator depending on the material thickness of the tube in the present invention.

FIG. 9 is a graph respectively illustrating flow rates and heat transfer rate of radiators according to the present invention and prior arts.

FIG. 10 is a graph respectively illustrating weights of radiators according to the present invention and the prior arts.

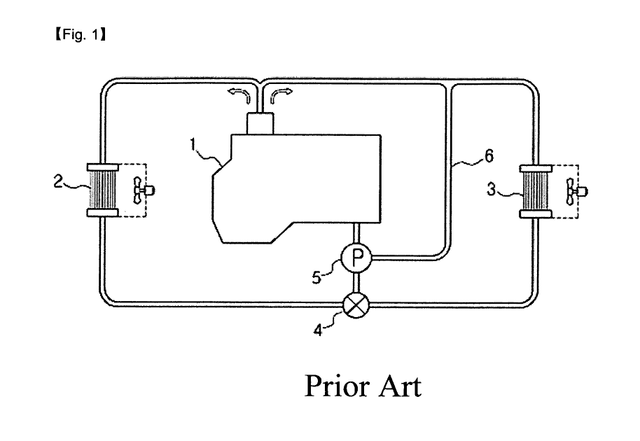

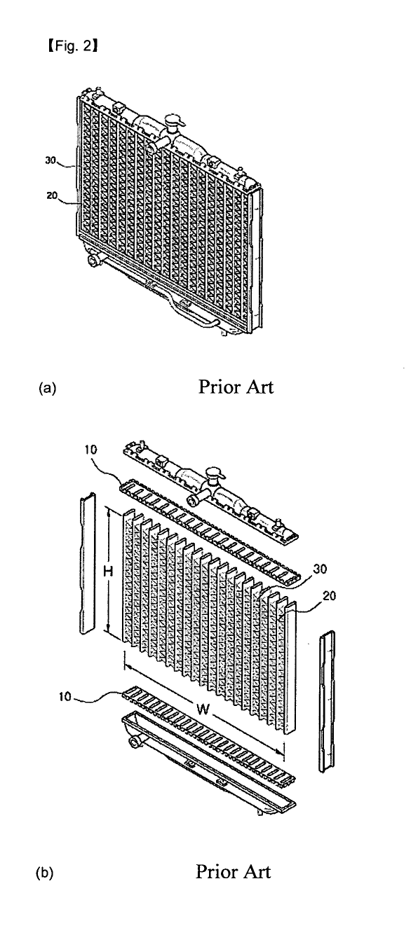

### DESCRIPTION OF MAIN ELEMENTS

10: radiator header

20: heat exchange tube of radiator

30: radiator fin

### BEST MODE FOR CARRYING OUT THE INVENTION

Practical and presently preferred embodiments of the present invention are illustrative as shown in the following Examples and Comparative Examples.

However, it will be appreciated that those skilled in the art, on consideration of this disclosure, may make modifications and improvements within the spirit and scope of the present invention.

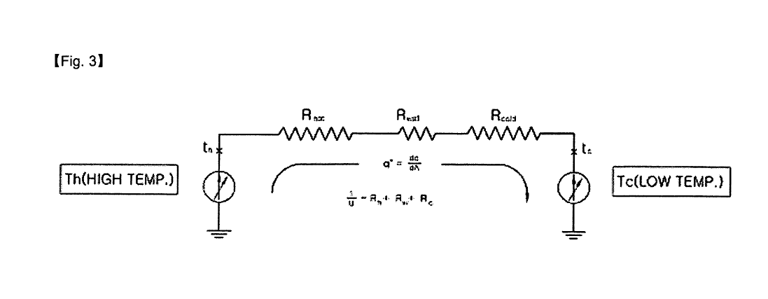

In order to interpret a heat transfer characteristic in a heat exchanger like the radiator shown in FIG. 2, the present invention derives a concept of thermal resistance as shown in FIG. 3 the same as electric resistance is expressed by a ratio of a voltage and a current in electrical engineering. At this time, a factor allowing heat transfer to be accomplished in the heat exchanger is a temperature difference, and a factor preventing a heat flow due to the temperature difference is set as the thermal resistance to be applied similarly to formula I=V/R, which is used in the electrical engineering. In this case, heat transfer rate q″ is expressed following formula, and heat transfer rate q″ is increased as thermal resistance R is small and temperature difference Th−Tc is large.

q″=C×(Th−Tc)/R (1)

Here, C denotes a constant, Th denotes a high temperature-side temperature, Tc denotes a low temperature-side temperature, and R denotes thermal resistance.

Meanwhile, thermal resistance R is again expressed with respect to each case of heat convection and heat conduction as follows.

Heat convection: R=1/hA (2)

Heat conduction: R=1/kA (3)

Here, h denotes a heat convection coefficient, k denotes a heat conduction coefficient, and A denotes a heat transfer area.

Total thermal resistance Rtot applied to the heat exchanger like the radiator of the present invention is expressed by the sum of thermal resistance Rh due to heat convection in the tube that is a high temperature side, thermal resistance Rc due to heat convection in the air that is a lower temperature side and thermal resistance Rwall due to heat conduction through the thickness of the tube itself as follows, and each of the thermal resistances is in proportion to a reciprocal of the multiplication of the heat transfer coefficient and the heat transfer area.

Rtot=Rh+Rc+Rwall (4)

However, although air-side heat convection occupies the largest portion of heat transfer rate due to the heat transfer in a case of the radiator, a variation of a heat radiation characteristic in accordance with a structure modification degree of its component is not so large, while, although the heat transfer rate due to the heat convection in the high temperature side heat exchange tube occupied a small portion of the total heat transfer rate, a change in heat transfer rate is sensitive in accordance with the structure modification degree of its component. Since a variation of the heat transfer rate is relatively large, the thermal resistance as a main factor for determining elements of the radiator and the heat radiation performance according thereto, is Rh in the aforementioned formula (4).

In the present invention, there will be suggested a preferred element range of main components in the radiator, in which Rh can be quantitatively defined on the basis of a heat transfer theory as described above, low weight can be implemented through a relationship with the elements of the radiator, and enhanced heat radiation performance can be displayed at the same time.

In the definition of the thermal resistance, the mean flow rate of the cooling water flowing into the tube of the radiator is one of the main factors for determining the heat radiation performance, and the mean flow rate of the cooling water is a value dividing the total flow rate flowing into the radiator by the total sectional area of the tube through which the cooling water flows. A power source for allowing the cooling water to flow is the water pump of the vehicle, but the flow rate and pressure loss is changed depending on the number and width of the tube although the total flow rate is uniformly maintained. For example, although a structure in that the width of the tube is narrow and the number of tubes is increased instead may increase the flow velocity in the tube, this results in increasing the pressure loss due to the increase of inflow resistance, while a heat transfer amount is reduced although the flow rate may be decreased if the width of the tube becomes large. Consequently, in order to get effective heat radiation performance, the width of the tube should be appropriate. Further, in order to increase the number of tubes under a condition of the same core area, a design should be made to have the optimal height of the fin corresponding to the width of the tube. The increase of the number of tubes increases the area of a water path through the cooling water flows so that the pressure loss can be reduced and the flow rate can be increased at the same time. Further, the height of the fin having a heat radiation effective area is also one of the main factors for optimizing an efficiency of the heat transfer. Accordingly, the material thickness and width of the tube and the height of the fin, which are conditions for allowing heat transfer rate per unit weight to be optimized, are appropriately determined as a reference for maximizing the heat radiation performance of the radiator, so that material costs of the radiator can be reduced and fuel consumption can be further enhanced.

Mean flow velocity Uw is a value dividing the entire flow rate of the cooling water by the sectional area of the tube, and it may be approximated as follows.

Uw=Qw/Ac (5)

Here, Qw denotes an entire flow rate of the cooling water, and Ac denotes a sectional area of the tube.

Further, when core width W of the radiator is given, tube number n of the radiator is identical with a value dividing the length excluding height Fh of one fin from core width W of the radiator by pitch Tp of the tube. At this time, since core width W is much larger than height Fh of the fin so that the relation of W>>Fh is mathematically made, tube number n may be defined as follows.

$$\begin{matrix}n = ( W - Fh ) / Tp \\ \approx W / Tp\end{matrix} \qquad ( 6 )$$

At this time, since the sectional area is identical with a value multiplying an internal sectional area by a tube number of the radiator, the sectional area of the tube is again expressed as the following formula.

$$\begin{matrix}Ac = b \times Td \times n \\ \approx b \times Td \times W / Tp\end{matrix} \qquad ( 7 )$$

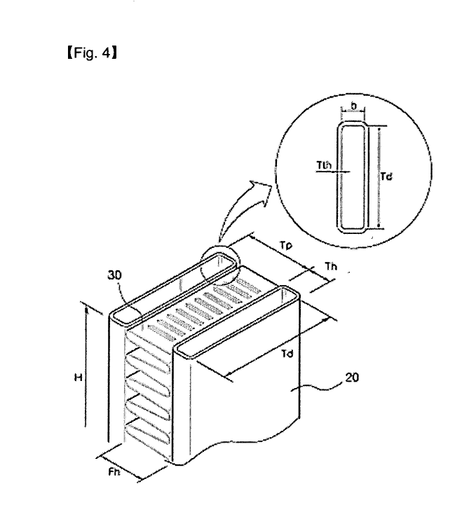

Here, b denotes an internal width of the tube, and Td denotes an internal height of the tube as shown in FIG. 4. Thus, mean flow velocity Uw of the cooling water in the tube is expressed by the following formula (7) from the formulas (5) and (7).

$$\begin{matrix}Uw = Qw / Ac \\ = Qw \times Tp / ( b \times Td \times W )\end{matrix} \qquad ( 8 )$$

Further, assuming that internal height Td of the tube, core width W and entire flow rate Qw are contant, the aforementioned formula (8) is again expressed by a function of internal width b and pitch Tp of the tube as follows.

Uw=C1×(Tp/b) (9)

Here, C1 denotes a constant.

Meanwhile, heat transfer area Aw of the tube means the entire surface area through which the cooling water can be wet in the tube. Since length H of the tube and width W of the core are constant, and the relation of Td>>b is made, assuming that (Td+b)≈Td, this is defined as follows.

$$\begin{matrix}Aw = 2 \times ( b + Td ) \times H \times n \\ \approx 2 \times Td \times H \times W / Tp \\ = C 2 \times ( 1 / Tp )\end{matrix} \qquad ( 10 )$$

Here, C2 denotes a constant.

Meanwhile, since, in order to enhance the heat radiation performance, the internal flow of the radiator is designed such that a turbulent flow is possible in most regions, in a case of the internal flow is a turblulent flow, Nusselt number Nu may be expressd by Dittus-Boelter equation as follows.

$$\begin{matrix}Nu = 0.023 \times {Re}^{0.8} \times {Pr}^{0.3} \\ = 0.023 \times {( ρ \times Uw \times Dh / μ )}^{0.8} \times {Pr}^{0.3} \\ = C 3 \times {( Uw \times Dh )}^{0.8}\end{matrix} \qquad ( 11 )$$

Here, ρ denotes a density of fluid, μ denotes a viscosity coefficient, and C3 is a constant. Since hydraulic diameter Dh is 4b×Td/2(b+Td), and b is a value relatively smaller than Td as assumed above, hydraulic diameter Dh is again approximated as the following formula.

Dh≈2b (12)

Meanwhile, Nusselt number Nu is a dimensionless number indicating a ratio in that heat is exchanged between a fluid and a solid, and it is defined as follows.

Nu=h×Dh/k (13)

Here, h denotes a heat transfer coefficient, and k denotes thermal conductivity of fluid.

Thus, heat transfer coefficient hw of an inner surface of the tube is defined from the aforementioned formulas (9), (11), (12) and (13) as follows.

$$\begin{matrix}Hw = C 4 \times {( Uw \times Dh )}^{0.8} / Dh \\ = C 4 \times {Uw}^{0.8} \times {Dh}^{- 0.2} \\ = C 5 \times {( Tp / b )}^{0.8} \times {( 2 b )}^{- 0.2} \\ = C 6 \times {Tp}^{0.8} / b\end{matrix} \qquad ( 14 )$$

Meanwhile, since a change in heat radiation characteristic in the radiator of the present invention is largely influenced by heat convection in a high temperature region of the tube as described above, it is very important to observe the variation and characteristic of the thermal resistance in this region. Therefore, thermal resistance Rw in the hight temperature region of the tube of the radiator is derived from the formulas (2) and (14) as follows.

$$\begin{matrix}Rw = 1 / ( hw \times Aw ) \\ = C 7 \times {Tp}^{- 0.8} \times b \times Tp \\ = C 7 \times b \times {Tp}^{0.2} \\ = C 7 \times ( Th - 2 Tth ) \times {( Th + Fh )}^{0.2}\end{matrix} \qquad ( 15 )$$

Here, Th denotes a width of the tube, Tth denotes a material thickness of the tube, and Fh denotes a height of the fin.

That is, a change in heat transfer rate due to the heat convection can be observed depending on a change in value of the thermal resistance Rw, and a preferred design element of components corresponding to the main factor among the components of the radiator can be suggested from its change result.

A preferred embodiment of the present invention will be described in detail below with reference to the accompanying drawings.

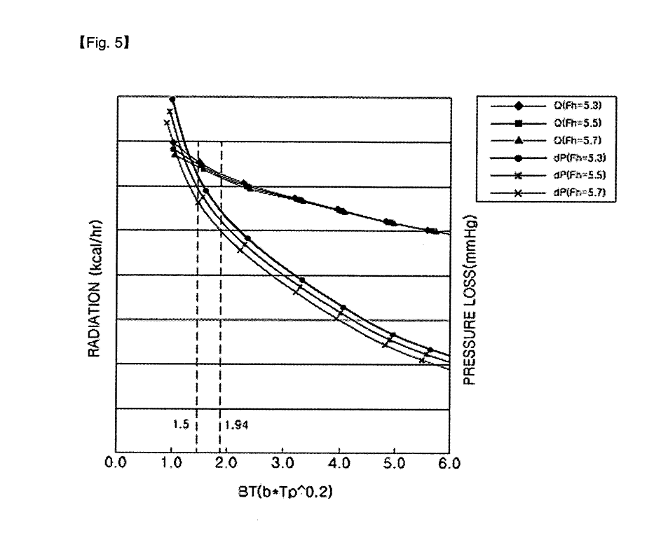

FIG. 5 is a graph illustrating a relation of thermal resistance Rw derived above and the heat transfer rate in the formula (1). In FIG. 5, the horizontal axis displays a change value of the variable except constant value C7 in the thermal resistance formula (15) as a variable, and the vertical axis displays heat transfer rate and pressure loss as a variable in a case where height Fh of the fin is 5.3 mm, 5.5 mm and 5.7 mm, respectively. As shown in FIG. 5, the heat transfer rate shows a slow change with respect to the change in thermal resistance Rw, but the pressure loss shows an aspect in that it is rapidly increased in a certain region, particularly less than a certain value.

Uppermost and lowermost values for selecting an appropriate range of the thermal resistance is apporopriately selected by means of the formula considering the heat transfer rate and the like required by the radiator. Theoretically, although the heat transfer rate is increased as the thermal resiatance becomes small, an appropriate range should be specified considering the pressure loss in the tube in a case of the lowermost value. When the uppermost and lower most values of the thermal resistance is selected with reference to FIG. 5, it should be simultaneously considered in that the pressure loss in a real tube is rapidly increased when the thermal resistance value is less than 1.5 in the horizontal axis of the graph in FIG. 5 and that it is disadvantageous when the thermal resistance value is more than 1.94 in a view of the heat transfer rate required by the radiator in a case of the lowermost value. Thus, an appropriate region where minimum heat radiation performance required by the radiator is shown and the pressure loss is not largely increased in the present invention is set as follows.

1.50≦(Th−2Tth)×(Th+Fh)^{0.2}≦1.94 (16)

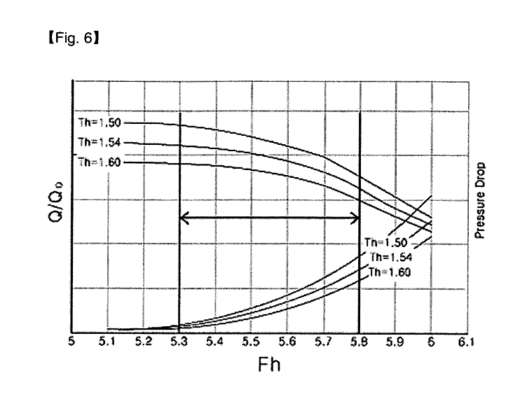

FIG. 6 is a graph illustrating a change in heat transfer rate and pressure loss of the radiator depending on height Fh of the fin when the height of tube Th is respectively 1.50 mm, 1.54 mm and 1.60 mm in the present invention. Here, Q is heat transfer rate of the radiator, i.e., a minimum required heat transfer rate of the radiator for cooling the engine. That is, in FIG. 6, the left vertical axis is Q/Q₀, Q₀ showing a minimum required heat transfer rate, and the right vertical axis shows a fluid-side pressure loss amount. At this time, the solid line of the graph indicates a heat transfer rate ratio, and the dotted line indicates a fluid-side pressure loss amount. Height Fh of the fin in the present invention can be set to have a preferred range from the graph of FIG. 6. That is, in a case where height Fh of the fin exceeds 5.8 mm, the heat transfer rate is dropped below the minimum required radiation calorifc value so that the temperature of the engine cannot be appropriately maintained, and in a case where the thickness of the fin is thin, the fin can be buckled. Meanwhile, there is a caused problem in that the number of stacked fins and tubes becomes excessively large at below 5.3 mm so that the weight of the radiator is largely increased, and fins and tubes work as a resistance to the flow of air. What is worse a foreign substance is excessively stacked due to a high density of the fin in an traveling condition of a real vehicle so that air passing through the radiator is not smoothly flowed. Thus, height Fh of the fin is set within a range where the heat transfer rate is maintained as a sufficiently high value and the pressure loss in the tube is not rapidly increased with reference to the required condition and the characteristic of FIG. 6. The following range is set as a preferred region.

5.3 mm≦Fh≦5.8 mm (17)

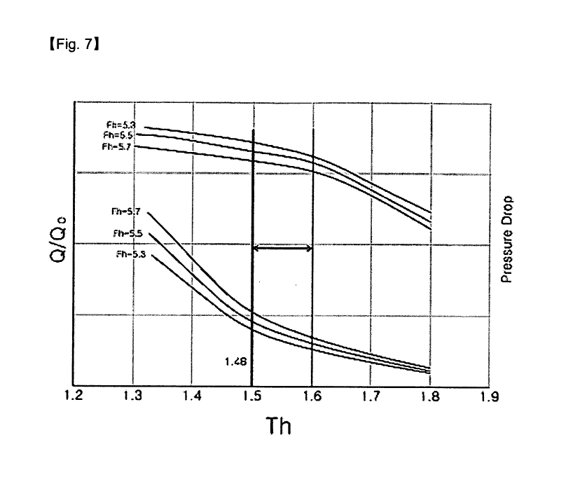

FIG. 7 is a graph illustrating a change in heat transfer rate and pressure loss of the radiator depending on height Th of the tube when height Fh of the fin is respectively 5.3 mm, 5.5 mm and 5.7 mm in the present invention. Height Th of the tube of the radiator of the present invention can be set to have a preferred range from the graph of FIG. 7. That is, there is cuased a problem in that, in a case where height Th of the tube exceeds 1.6 mm, a fluid flowing in the tube is difficult to become turbulent flow so that the heat transfer rate is dropped below the minimum required heat transfer rate, and on the contrary, in a case where height Th of the tube is below 1.5 mm, the fluid-side pressure loss amount in the tube is rapidly increased so that excessive power is required to circulate the fluid. Thus, height Th of the tube is set within a range where the heat transfer rate is maintained as a sufficiently high value and the pressure loss in the tube is not rapidly increased with reference to the required condition and the characteristic of FIG. 7. The following range is set as a preferred region.

1.48 mm≦Th≦1.6 mm (18)

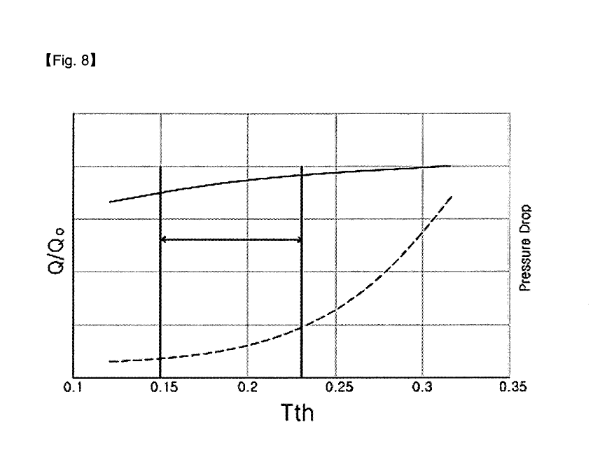

FIG. 8 is a graph illustrating a change in heat transfer rate and pressure loss of the radiator depending on material thickness Tth of the tube in the present invention. Material thickness Tth of the tube in the radiator of the present invention is set to have a preferred range from the graph of FIG. 8. That is, there is a problem in that, as material thickness Tth of the tube becomes thick, the weight of the radiator is increased and the fluid-side pressure loss amount is largely increased so that excessive power is required to circulate the fluid. On the other hand, there is problem in that, in a case where material thickness Tth of the tube is below 0.15 mm, the materal becomes too thin so that the tube may be highly modified when injecting the fluid in a manufacturing process, and the tube may be burst or the stacked fin of the core may be crushed due to a problem of pressure resistance. Thus, material thickness Tth of the tube is set within a range where the heat transfer rate is maintained as a sufficiently high value and the pressure loss in the tube is not rapidly increased with reference to the required condition and the characteristic of FIG. 8. The following range is set as a preferred region.

0.15 mm≦Tth≦0.23 mm (19)

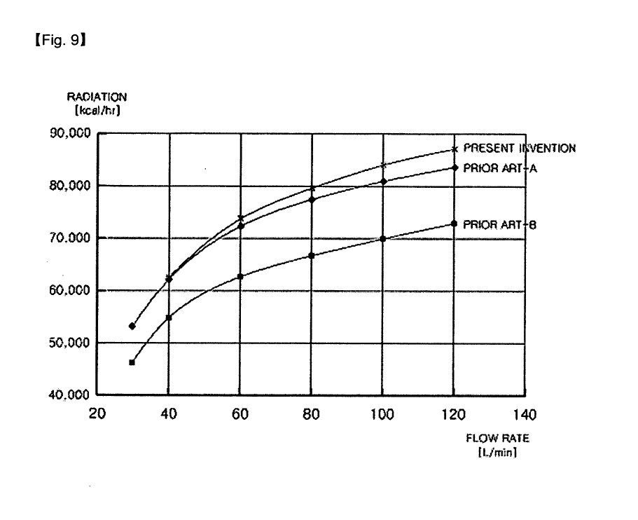

The present invention has suggested a preferred design condition of the tube and the fin, which meets the thermal resistance range conditions described above and promotes the low weight of the radiator at the same time. Further, it can be seen that the heat radiation performance of the radiator employing this has been enhanced as compared with the conventional radiator in FIG. 9.

FIG. 9 is graph in which the heat transfer rate of the convential radiator product with the same heat exchange value is compared with that of the radiator satisfying Fh, Th and Tth conditions of the present invention under the same air-side pressure loss condition. Here, the pressure loss condition of each of the radiators is set to have the same value by adjusing the density of fins (FPDM) with respect to each width.

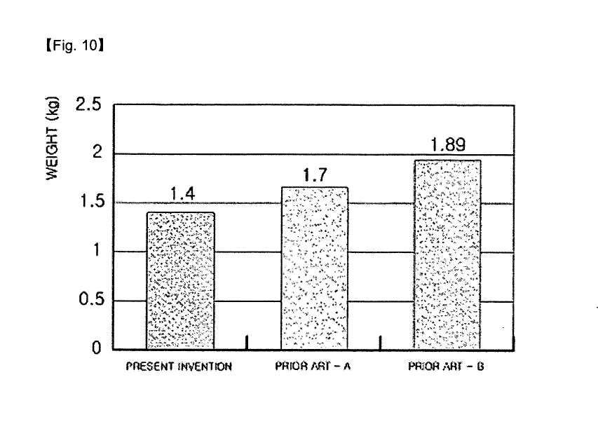

FIG. 10 is a graph in which the total weights of the tube and the fin are compared when the size of core W, that is a heat exchange area of the radiator, is the same. As shown in FIG. 10, the radiator of the present invention implements low weight as compared with the conventional radiator with the same core size so that it directly helps a vehicle with the enhancement of fuel consumption.

### INDUSTRIAL APPLICABILITY

As described above, since a radiator of the present invention reduces the weight of a vehicle body and enhances heat radiation performance, it has a large effect on low weight and increase of fuel consumption.

Further, the present invention can suggest an optimal design range for maximizing the the heat radiation performance of the radiator using a concept of thermal resistance.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A heat exchanger for a vehicle for exchanging heat between cooling water heated by an engine and air flowing into the front of the vehicle to cool the engine, comprising:
a header at one side for communicating the cooling water supplied from the engine through a thermostat for adjusting opening and shutting depending on a temperature of the cooling water and a water pump;
heat exchange tubes which are structurally fastened to communicate with the heater at one end portion thereof, and arranged in parallel to a direction of driving wind;
a header at the other side which is structurally fastened at the other end portion of the heat exchange tubes to communicate therewith, to discharge the cooling water into the engine; and
fins fixedly brazed between the heat exchange tubes,
wherein the inner width b and pitch Tp of each tube is determined by the formula 1.50≦b×Tp^{0.2}≦1.94, which is derived from thermal resistance Rw, when the material thickness Tth of the tube is within the range from 0.15 to 0.23 mm.

2. The heat exchanger as set forth in claim 1, wherein the flow of the cooling water within each tube is a turbulent flow in most regions.

3. The heat exchanger as set forth in claim 1, wherein the inner width b of each tube is within the range from 1.02 to 1.3 mm.

4. The heat exchanger as set forth in claim 1, wherein the pitch Tp of each tube is within the range from 6.78 to 7.4 mm.

5. The heat exchanger as set forth in claim 1, wherein the outer width Th is within the range from 1.48 to 1.6 mm.

6. The heat exchanger as set forth in claim 1, wherein the height Fh of the fin is within the range from 5.3 to 5.8 mm.
